(19) United States
(12) Patent Application Publication
(10) Pub. No.: US 2002/0066652 A1
(43) Pub. Date: Jun. 6, 2002

(54) Multi-directional ball switch and operation method thereof

(76) Inventor: Chang Ryul Lee, Seoul (KR)

Correspondence Address: BIRCH STEWART KOLASCH & BIRCH, PO BOX 747, FALLS CHURCH, VA, 22040-0747, US

(21) Appl. No.: 09/931,021

(22) Filed: Aug. 17, 2001

(30) Foreign Application Priority Data
Aug. 18, 2000 (KR) 2000-47940
Jul. 23, 2001 (KR) 2001-44297

(51) Int. Cl. H01H 9/26

(52) U.S. Cl. 200/5 R

(57) ABSTRACT

The present invention relates to a multi-directional ball switch, which simplifies a complicated switching system equipped in an electronic instrument to be quickly operated by constructing a ball switch of which the rotational direction of the ball is specifically controlled by using numbers of wheels and frictional force of click encoders, and operation method thereof.

A multi-directional ball switch in accordance with the present invention comprises: a panel having 4 diagonally-located fixtures, each of which has an orthogonal shaft-hole; a ball knob placed on the panel; a conversion means that transforms the rotation of the ball knob into an electric signal; a CPU connected to the conversion means and to a sound generation section; a switching section which restrains the rotation of the ball knob and selectively generates an output from CPU; and a signal generation section connected to CPU. And thus, it can be quickly controlled by reducing finger movement as well as be conveniently used without requiring an extra training.

### BACKGROUND OF THE INVENTION

1. Field of the Invention

The present invention relates to a multi-directional ball switch and operation method thereof. More particularly, it controls the rotational direction of a ball to be up-, down-, left-, right-, or pressing-direction using numbers of wheels and frictional force to simplify a complicated switching system equipped in an electronic instrument. Thus, it can accomplish a quick, accurate control of an electronic instrument as well as reduce the manufacturing cost thereof.

2. Description of the Related Art

In general, an electronic instrument such as a TV, a VCR, an A/V, a remote controller, a monitor, or a home automation system is equipped with numbers of function keys for ON/OFF, setting a new mode and/or modifying a mode set, screen control, and so on.

In addition, as numbers of convenient functions for various instruments are added to switching system by virtue of electronic technology development, number of switches to control an instrument has been increased. Thus, a switch is no more a simple ON/OFF switch, but has various functions such as mode setting, screen control, and reset control by means of combining numbers of button-presses and control sequences.

For example, “An operation control device for television using a ball mouse and method of using the same” is disclosed in KR 1997-68598.

The operation control device mentioned above comprises: a ball mouse installed at front-side of a television to control up/down of channels and volume; a Y-axis rotation sensing means to detect Y-directional rotation of the ball mouse and provide a corresponding sensing signal; an X-axis rotation sensing means to detect X-directional rotation of the ball mouse and provide a corresponding sensing signal; a signal processing section to transform the sensing signals from X- and Y-axis rotation sensing means into digital signals; a control section which calculates X- and Y-axis rotation amount based on the sensing data from the signal processing section, compares the calculated X- and Y-axis rotation amount and thereafter controls television function corresponding to an axis having larger rotation amount; a channel controller to control up/down of channel according to the control signal from the control section; and a volume controller to control up/down of volume according to the control signal from the control section so that it can simply and easily accomplish channel/volume control.

The operation control device for television mentioned above, however, has disadvantages that it is hard to discriminate the rotational direction and, after it is selected, user has to press another switch to input the signal.

On the other hand, in case of a complicated instrument, a switching system generally comprises a main switch and numbers of sub-switches so that a control is carried out by first selecting a menu or a function by pressing the main switch, then changing it into setting mode by pressing a sub-switch, and thereafter selecting desired date, time, memory, color, size, volume, balance, and so on.

However, in order to effectively control numbers of various functions of an electronic instrument, numbers of various switches are required. Consequently, the volume becomes larger and it takes time to understand the accurate functions of a switching system due to the complexity of a user's manual.

Due to the problems mention above, a general user only uses the most basic functions, and even a custom user, who acknowledges the whole functions, can not utilize the whole functions effectively because of controlling inconvenience.

And, in case of a remote controller of an electronic instrument, the size becomes unnecessarily large, and when selecting a switch, user has to read numbers of function characters indicated on various switches to find a desired one. Also, an error could occur by pressing a neighboring switch instead.

To solve the problems mentioned above, the applicant proposed “A multi-directional ball switch” in KR 2000-17341011 (application data: Aug. 18, 2000).

A multi-directional ball switch disclosed in the prior application comprises: a bracket comprising 4 diagonally-located fixtures, each of which has an orthogonal shaft-hole and a flowing-prevention element, and a hinge element having a hinge hole between the first and the second fixtures; a ball knob placed on the bracket; a conversion means that transforms the rotation of the ball knob into an electric signal; a CPU connected to the conversion means and to a sound generation section; and a selective control means that restrains the rotation of the ball knob and selectively generates an output from CPU, and thus it controls the rotational direction of the ball to be specified by using numbers of wheels and frictional force and thereby simplifies a complicated switching system equipped in an electronic instrument to be quickly and conveniently controlled without requiring an extra training.

However, in a ball switch described above, the rotation of ball knob is restrained by edges of 4 fixtures, extra flowing-prevention elements are required to prevent the ball knob from flowing, and a rotation shaft having side wheels at both sides are equipped to be rotated by contacting the ball knob. Thus, it has a problem of high manufacturing cost due to the increase of the number of manufacturing steps.

### SUMMARY OF THE INVENTION

The present invention is proposed to solve the problems of the prior art mentioned above. It is therefore the object of the present invention to provide a multi-directional ball switch, which comprises: a panel having 4 diagonally-located fixtures, each of which has an orthogonal shaft-hole; a ball knob placed on the panel; a conversion means that transforms the rotation of the ball knob into an electric signal; a CPU connected to the conversion means and to a sound generation section; a switching section which restrains the rotation of the ball knob and selectively generates an output from CPU; and a signal generation section connected to CPU so that it increases the number of contacting points of a ball to control the directions of up/down and left/right rotation and front/back press of the ball. Therefore, a multi-directional ball switch in accordance with the present invention simplifies a complicated switching system to be quickly controlled as well as reduces its manufacturing cost.

### BRIEF DESCRIPTION OF THE DRAWINGS

FIG. 1 is a disassembled perspective view of a multi-directional ball switch in accordance with the present invention.

FIG. 2 is a perspective view of a multi-directional ball switch in accordance with the present invention.

FIG. 3 is a plane view of a multi-directional ball switch in accordance with the present invention.

FIG. 4a and FIG. 4b are views illustrating operating states of a press sensor of a multi-directional ball switch in accordance with the present invention.

FIG. 5 is a block diagram illustrating the structure of a multi-directional ball switch in accordance with the present invention.

FIG. 6 is a flow chart illustrating a character-input process using a multi-directional ball switch in accordance with the present invention.

### Description of the Numerals on the Main Parts of the Drawings

2: a panel

3: a ball knob

4: a conversion means

5: a sound generation section

5a: a speaker

6: a CPU

6b: a signal generation section

7: a switching section

9: a first fixture

10: a second fixture

11: a third fixture

12: a fourth fixture

14: a shaft hole

22: a first click encoder

23: a second click encoder

24: a third click encoder

25: a fourth click encoder

26-29: rotation shafts

33: a supporting plate

33a: a hinge hole

34: a hinge shaft

36: a supporting ball

38: a stopper

39: a press sensor

### DETAILED DESCRIPTION OF THE EMBODIMENTS

Hereinafter, referring to appended drawings, the structures and the operation procedures of the embodiments of the present invention are described in detail.

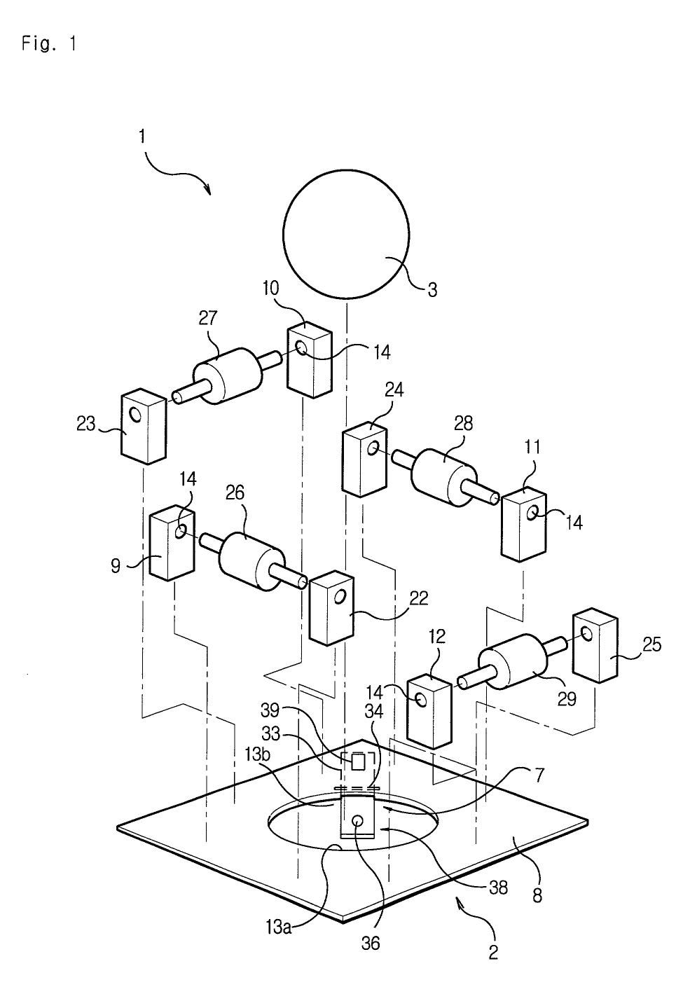

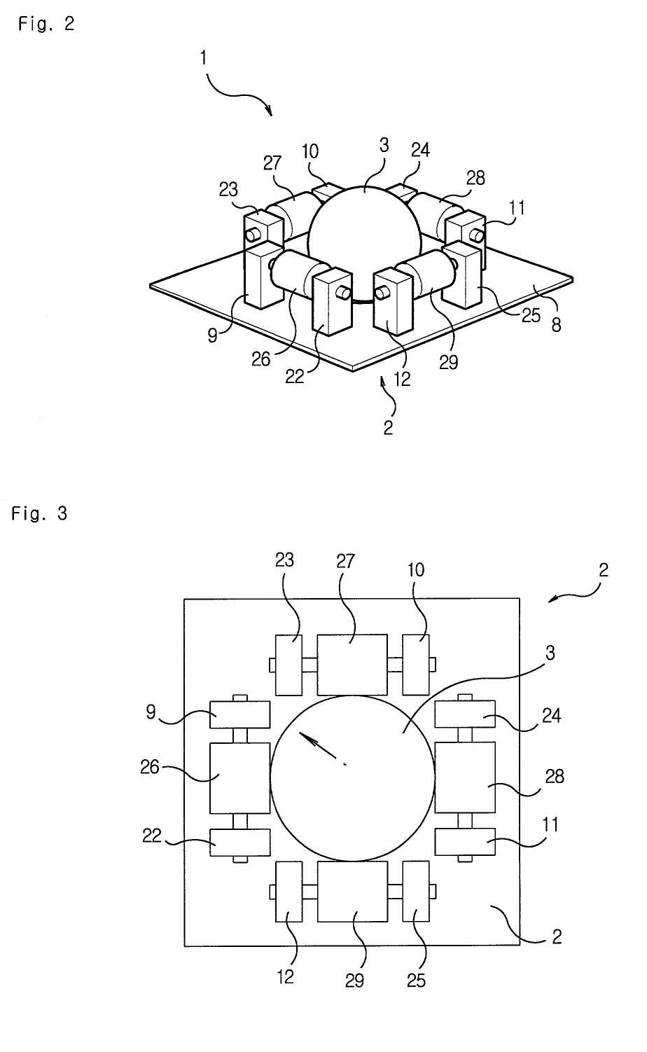

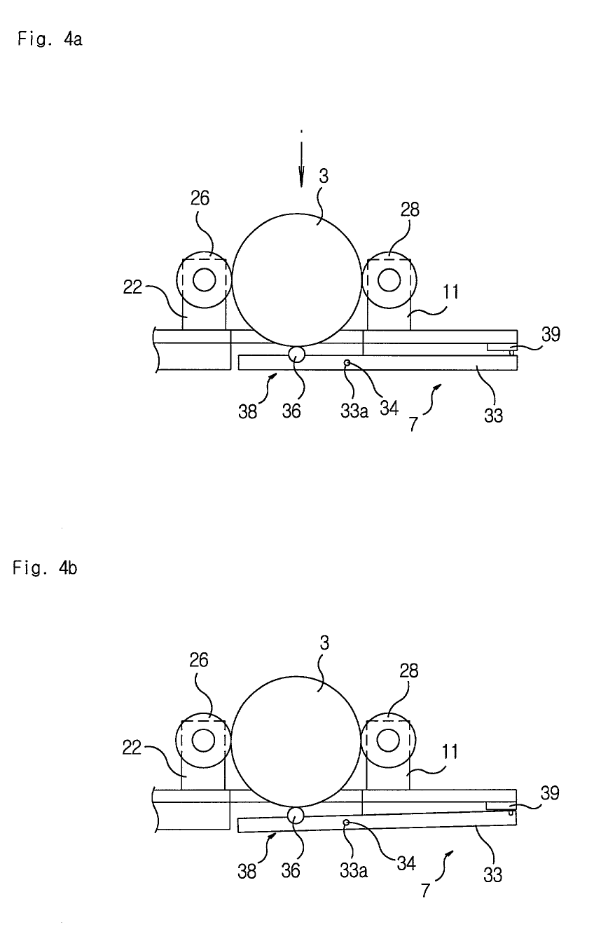

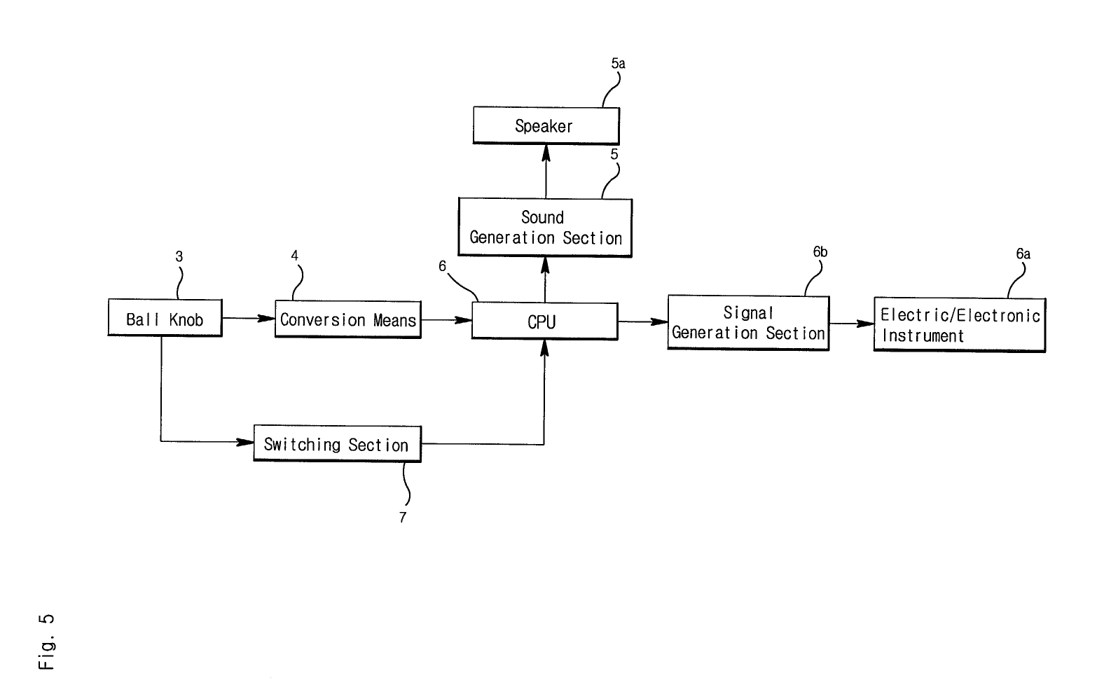

As described in FIG. 1˜FIG. 4, a multi-directional ball switch (1) in accordance with the present invention comprises: a panel (2); a sphere-shaped ball knob (3) placed on the panel (2); numbers of conversion means (4) that transform the rotation of the ball knob (3) into an electric signal; a CPU (6) that receives an electric signal from the conversion means (4) and outputs an output value through a signal generation section (6b) to an electric/electronic instrument (6a) to be controlled; and a switching section (7) that restrains the rotation and the rotational direction of the ball knob (3) and selectively generates an output value from CPU. Here, the panel (2) can be a main body of an electronic instrument or an extra PCB (8) fixed or adhered to the main body of an electronic instrument. 4 fixtures (9˜12) and 4 click encoders (22˜25) are diagonally installed on the PCB (8), and a penetration hole (13a) is formed at the center of the PCB (8) with a hinge element (13b) being established at one side so that the ball knob (3) can be placed thereon with a certain depth.

The fixtures (9˜12) are fixed on the PCB (8) by soldering and a shaft hole (14) is formed to penetrate through each fixture.

The outside of the ball knob (3) is desired to be coated by a soft rubber material.

The conversion means (4) comprises 4 click encoders (22˜25) that are installed to face 4 fixtures (9˜12) fixed on the panel (2) and 4 rotation shafts (26˜29) that are rotationably fixed in the shaft holes (14) of the fixtures (9˜12) and connected to the click encoders (22˜25).

Here, the click encoders (22˜25) transforms the rotation of the rotation shafts (26˜29) into electric signals at the time of rotation, and it is desirable to generates a click sound or a click vibration for user to notify the clicking movement.

Each of the rotation shafts (26˜29) is installed to be rotated to the direction of up/down or left/right, and it is constructed to be rotated to the exact horizontal (or vertical) direction automatically even when the ball knob (3) is pushed to almost but not exact to horizontal (or vertical) direction of the shaft.

In other words, in case that the ball knob (3) is pushed to a direction tilted a little upward (or downward) from horizon, the rotation shafts contacted at both sides of the ball knob (3) take roles for supporting the ball knob (3) like hinge shaft, so that the ball knob (3) can be easily rotated.

A CPU (6) receives electric signals from the conversion means (4), and it is also connected to a sound generation section (5) having a speaker (5a), which generates 5 different characteristic sounds according to 4 rotational directions of up/down/left/right and an ON/OFF of a switching section (7).

In addition, a signal generation section (6b), which generates a signal to control an electric/electronic instrument (6a), is connected to another output end of CPU (6).

For setting characteristic sounds from speaker (5a), it is desirable to set a sound to be symbolically relative to an operational direction of a switch, such that a short high sound for upward direction, a short low sound for downward direction, a short high-to-low sound for left direction, a short low-to-high sound for right direction, and a long mid sound for pressing direction.

The switching section (7) comprises a hinge element (13b), having a hinge hole (33a) at one side, installed on PCB (8), a supporting plate (33) having a stopper (38) equipped with a supporting ball (36) to support the ball knob (3), and a press sensor (39) installed at the downside of the panel (2) at the location counter to the stopper (38).

The operation principles of the present invention are now described in detail.

If the ball knob (3) is pushed by fingers to the left, the ball knob (3), which is supported by the supporting ball (36), rotates with being in contact with the surface of a rotation shaft (26) that is rotationably installed between the first fixture (9) and the first click encoder (22).

Here, if the ball knob (3) is pushed to the direction (→ direction in FIG. 3) tilted by a certain angle from horizontal direction, the surface of the ball knob (3) is in contact with a couple of rotation shafts (26 and 27). And then, since the rotation shafts (26 and 27) are connected to the first and the second click encoders (22 and 23) respectively, the load on clicking device increases due to the increase in number of contacted encoder and the contact angle, and the rotation is restrained thereby.

Under the circumstance described above, if pushing direction of the ball knob (3) is slightly changed to the left, the rotation shafts (27 and 29) restrains up/down rotation of the ball knob (3) and the rotation is limited only to horizontal direction.

In other words, the rotation shafts (26˜29) can be specifically rotated even if a user pushes the ball knob (3) into a tilted direction. Thus, an accurate control is possible.

During the procedure, an electric signal is generated at the first click encoder (22), installed at an end of the rotation shaft (26), by the rotation shaft (26) being rotated by the ball knob (3), and a click sound or a click vibration is generated at the same time.

The vibration is delivered to user's finger by way of the ball knob (3) and the rotation shaft (26) so that the user can acknowledge that the rotation shaft (26) is rotating, and the user can also acknowledge how many clicks are moved according to the amount (numbers) of vibrations.

The electric signal generated by ball knob (3) is applied to CPU (6) as ON/OFF signal, and at the same time, CPU (6) generates a characteristic sound through a speaker (5a), installed at a sound generation section (5), according to the rotational direction to notify the rotational direction of the ball knob (3).

Next, if the ball knob (3) is pressed into the direction of the supporting plate (33), the ball knob (3) presses the supporting ball (36) to rotate centering around the hinge hole (33a) and turns the press sensor (39) to be ON so that CPU (6) generates an output value and transmits it to an electric/electronic instrument (6a) to be controlled through a signal generation section (6b).

When fingers are taking off from the ball knob (3), the ball knob (3) returns upward by elastic force of the press sensor (39) and waits for next operation.

The operation procedures of a multi-directional ball switch in accordance with the present invention are explained herein only for the case of the ball knob (3) being pushed to the left, however, it is operated by following the same procedures for the cases of pushing to the right, upward, or downward.

A ball knob used in the present invention is basically able to handle 5 kinds of switching functions of up/down/left/right and press. If up/down and/or left/right movements are used for volume control, it can function as 3 switches and 1 volume controller, or 1 switch and 2 volume controllers. In addition, by utilizing 4 directional switching functions, it can perform a combined function of a fixed mouse and a switch.

By discriminating the 4 directional switching controls in a way that 1 click is for a short signal and more than 3 clicks is for a long one, it can handle 9 switching functions including a press function. Moreover, it can also handle 4 more switching functions by pushing the ball knob with being presses, and it is also possible to discriminate the levels of pressure loaded on the press sensor (39).

An example of an operation method of the ball switch is to match the rotational direction of the ball to the number plate of a telephone such that 1=rotate upward and to the left and press, 2=rotate upward and press, 3=rotate upward and to the right and press, 4=rotate to the left and press, 5=press, . . . , 0=rotate downward for 2 clicks and press, Enter=press twice.

It is another example of an operation method that, for the case of map-search on Internet, 4 directional movements of the ball knob (3) scroll a cursor to the corresponding 4 directions on the map and, if the ball knob (3) is moved up or down at a certain point with being pressed, a designated portion of the map is enlarged or contracted.

It is yet another example of an operation method that, for the case of web-search on Internet, a cursor is quickly moved into a prescribed position of a search window or an execution command indicated on web page by rotating a ball knob to up/down/left/right directions, and a web-search window can be changed by rotating the ball knob (3) to up/down/left/right directions with being pressed.

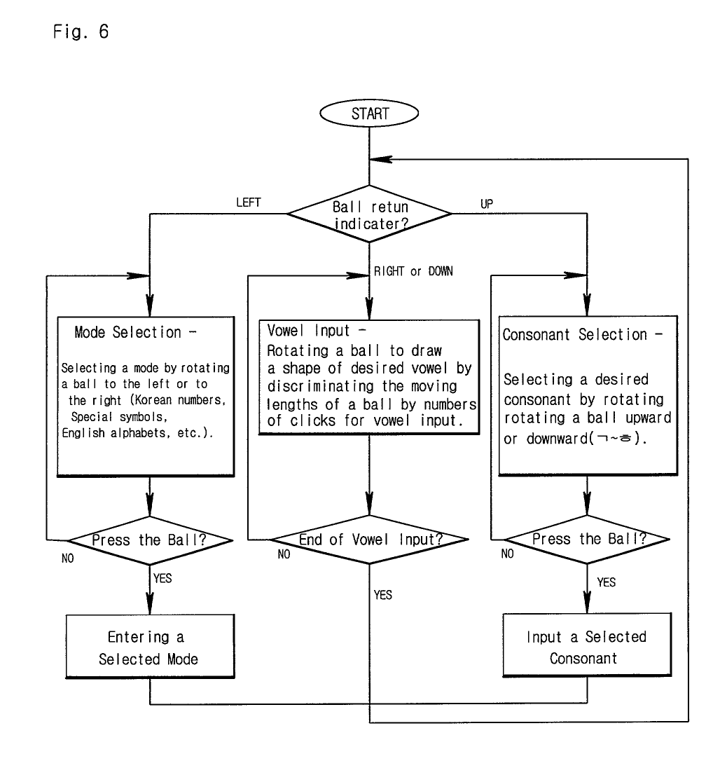

In addition, by combining the moving directions of a ball knob in an instrument having a display device, characters can be directly input without using a keyboard (described in FIG. 6).

In other words, in case of Korean alphabet, after moving the ball knob upward to select a consonant input mode, user scrolls the ball knob upward/downward to select a desired consonant. And then, by using the short/long movements of the ball knob to the right and/or downward directions, a desired vowel can be drawn to input.

In the case of English alphabet, by discriminating ball knob movements according to the corresponding characters, a desired alphabet can be selected.

In case of using a ball switch in accordance with the present invention by combining with a display, by displaying the functions according to its controlling directions on the screen and changing the screen to an appropriate one whenever the menu is changed, most of switching functions can be carried out by a single ball switch. Moreover, it can be directly applicable for a TV or a monitor, which has a display, without using an extra device.

In case of using a couple of ball knobs of the present invention for interlocking to a screen display function of a TV, one can be used for two steps of menu setting by controlling left/right movements of up/down directions and the other can be used for function setting.

In case of controlling the screen of a computer monitor by using a single ball knob, the ball can move a cursor to the left/right/up/down directions corresponding to screen directions on a certain menu, and it can enlarge or contract the screen to the left/right/up/down on another menu.

In case of applying the present invention for a car-audio system or an air-conditioning control, up/down movements can be used for selecting a radio or a CD player, left/right movements for volume control, and pressing can be used for selecting radio frequency or a desired CD.

In case of applying the present invention for being interlocked to a display and using up/down movements for main menu and left/right movements for an auxiliary menu, the whole menu system can be easily acknowledged without an extra movement of fingers by displaying main menu vertically on the screen and, when clicking to select one of them, displaying the auxiliary menu corresponding to selected main menu horizontally.

In addition, for inputting a time data to an electronic instrument, left/right movements can be used for selecting year, month, data, hour, or minute and up/down movements can be used for increasing/decreasing the number to select a desired one.

When applying the present invention for a TV, by using up/down movements for channel selection and left/right for volume control, channel selection can be performed at one point, volume control can be followed right after the channel selection, and on the pressing state, the number can be changed into its 10 multiples.

Furthermore, by applying all the multi-directional functions of a ball knob used for the present invention for all the electronic instruments (including home automation system), one can conveniently control the instruments and, by combining the switch with a display device of an universal remote control system, all the various control mechanism of various instruments can be handled by using a single ball switch.

As mentioned thereinbefore, the present invention presents a multi-directional ball switch that controls the rotational direction of a ball knob to be specified by using numbers of wheels and frictional force of click encoders. And thus, it can simplify the complicated switching system in an electronic instrument to be quickly and conveniently operated without requiring an extra training. In addition, it can be simply and easily controlled without reading the function characters and/or the indication characters on the switches. Thus, it can be used even in the dark.

Since those having ordinary knowledge and skill in the art of the present invention will recognize additional modifications and applications within the scope thereof, the present invention is not limited to the embodiments and drawings described above:

What is claimed is:

1. A multi-directional ball switch comprising:
a panel (2) having 4 diagonally-located fixtures (9˜12), each of which has an orthogonal shaft-hole (14);
a ball knob (3) placed on said panel (2);
a conversion means (4) that transforms the rotation of said ball knob (3) into an electric signal;
a CPU (6) that is connected to said conversion means (4) and to a sound generation section (5);
a switching section (7) that restrains the rotation of said ball knob (3) and generates an output value from said CPU (6); and
a signal generation section (6b) connected to said CPU (6).

2. A multi-directional ball switch as claimed in claim 1,
wherein said conversion means (4) comprises:
4 rotation shafts (26˜29) that are inserted into the shaft holes (14) of said 4 fixtures (9˜12) respectively; and
4 click encoders (22˜25) into which ends of said 4 rotation shafts (26˜29) are inserted respectively;
wherein bottoms of said 4 click encoders (22˜25) are fixed on said panel (2)

3. A multi-directional ball switch as claimed in claim 1,
wherein said sound generation section (5) is established to generate different characteristic sounds through a speaker (5a) according to the directions of movements of said ball knob (3) such as up, down, left, right and press.

4. A multi-directional ball switch as claimed in claim 1,
wherein said switching section (7) comprises:
a supporting plate (33) having a hinge hole (33a);
a hinge shaft (34) that is inserted into said hinge hole (33a);
a stopper (38) that is equipped with a supporting ball (36) located at the center of said supporting plate (33); and
a press sensor (39) that is installed between the top of free-end of said supporting plate (33) and the down surface of said panel (2).

5. A multi-directional ball switch as claimed in claim 2,
wherein said rotation shafts (26˜29) are installed to support both sides of said ball knob (3) so that said ball knob (3) can rotate only one direction of up/down or left/right at a time.

6. A multi-directional ball switch as claimed in claim 2,
wherein said 4 click encoders (22˜25) are constructed to generate a click sound or a click vibration while said rotation shafts (26˜29) are rotating.

7. An operation method of a multi-directional ball switch characterized in that, for the case of map search on Internet, a cursor is scrolled into 4 directions on the map, and at said scrolled position, a designated portion of said map is enlarged or contracted by moving said ball knob upward or downward in a pressing state.

8. An operation method of a multi-directional ball switch characterized in that, for the case of web-search on Internet, a cursor is quickly moved into a prescribed position of a search window or an execution command indicated on web page by rotating a ball knob to up/down/left/right directions, and a web-search window can be changed by rotating said ball knob to up/down/left/right directions with is being pressed.

9. An operation method of a multi-directional ball switch characterized by, for the case of inputting Korean alphabet, moving a ball knob upward to select a consonant input mode, scrolling said ball knob upward/downward to select a desired consonant, and thereafter selecting a desired vowel by using the short/long movements of said ball knob to the right and/or downward directions.
